(19) United States
(12) Patent Application Publication
(10) Pub. No.: US 2026/0055488 A1
(43) Pub. Date: Feb. 26, 2026

(54) HIGH TEMPERATURE FLOW COMPONENTS

(71) Applicant: Emerson Process Management Regulator Technologies, Inc., McKinney, TX (US)

(72) Inventors: Geradro Gamboa, McKinney, TX (US); Ali Babakr, McKinney, TX (US)

(21) Appl. No.: 19/309,476

(22) Filed: Aug. 25, 2025

Related U.S. Application Data
(60) Provisional application No. 63/687,098, filed on Aug. 26, 2024.

(51) Int. Cl. C22C 21/04; F16K 25/00

(52) U.S. Cl. CPC C22C 21/04; F16K 25/005

(57) ABSTRACT

A flow component for a valve and related methods is disclosed herein. The flow component can include a component body formed from a metal matrix composite (MMC) material (e.g., heat resistant metal matrix composite). The MMC material can include between 70 wt. % to 95 wt. % Al, between 1 wt. % to 25 wt. % Si, and between 1 wt. % to 15 wt. % grain-refining material.

### CROSS-REFERENCE TO RELATED APPLICATIONS

This application is related to, claims priority to, and incorporates herein by reference for all purposes U.S. Provisional Patent Application No. 63/687,098, filed Aug. 26, 2024.

### BACKGROUND

Regulators can be used to regulate pressure and control flow for the distribution of a fluid. In particular, some regulators may be service regulators that can be configured to reduce the pressure of fluid (e.g., natural gas) from high-pressure main line and to control the flow rate of the fluid to meet downstream demand while maintaining downstream pressure within a desired range.

### SUMMARY

Embodiments of the invention can provide an improved flow components for regulators or other valves. Some embodiments can provide improved diaphragms for regulators, including service regulators for the distribution of a fluid such as natural gas.

In some examples, a flow component for a valve can include a component body formed from a composite metal matrix material. The composite metal matrix can include between 70 wt. % and 95 wt. % Al, between 1 wt. % and 25 wt. % Si, and between 1 wt. % and 15 wt. % grain-refining material.

The metal matrix composite material can include: between 80 wt. % and 90 wt. % Al; between 2 wt. % and 15 wt. % Si; and between 4 wt. % and 8 wt. % grain-refining material.

The metal matrix composite material can include between 8 wt. % and 10 wt. % grain-refining material.

The metal matrix composite material can include: about 90 wt. % Al; about 2 wt. % Si; and about 8 wt. % grain-refining material.

The metal matrix composite material can include less than about 15 wt. % Si. In particular examples, the metal matrix composite material can include less than about 12 wt. % Si.

The grain-refining material can be selected from the group consisting of cerium, carbon nanofibers, and strontium.

The component body can be a diaphragm for a regulator.

In some examples, a method of preparing a flow component can include: melting Al, Si and a grain-refining material to form a melt; raising the temperature of the melt; and allowing the melt to cool to form a composite material. The composite material can include: between 70 wt. % and 95 wt. % Al; between 1 wt. % and 25 wt. % Si; and between 1 wt. % and 15 wt. % grain-refining material.

The Al can be melted to be molten Al, and the Si and the grain-refining material can be combined with the molten Al to form the melt.

The temperature of the melt can be raised to 1500° C. and held for a sufficient time period to ensure the Si has melted into the Al matrix and is homogeneously distributed.

The melting can be arc melting. In some examples, the arc melting can be conducted in a vacuum.

The method can further include: heating the composite material; and forming the composite material into a flow component. In particular examples, the heating can include heating the composite material at a rate of between about 100° C./hr and 350° C./hr to a temperature, and maintaining the composite material at the temperature. The temperature can be between about 100° C. and about 300° C.

The flow component formed by the method can be a diaphragm (e.g., configured for use in a regulator).

In some examples, a valve can include a valve body that defines an inlet, an outlet, and a fluid flow path from the inlet to the outlet, and a flow components within the body to control flow of fluid along the fluid flow path. The flow component can be formed from a composite material that includes: between 70 wt. % and 95 wt. % Al; between 1 wt. % and 25 wt. % Si; and between 1 wt. % and 15 wt. % grain-refining material.

The valve can be a regulator.

The flow component can be a diaphragm of the regulator.

The grain-refining material can include strontium at less than 1 wt % or cerium at less than 5 wt %.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 is a cross-section view of a regulator with a diaphragm, according to some embodiments of the invention.

FIG. 2 is a perspective view of a diaphragm of the regulator of FIG. 1.

FIGS. 3A through 3C are cross-section views of additional regulators with diaphragms, according to some embodiments of the invention.

FIG. 4 is a flowchart of a method of manufacturing a diaphragm according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, regulators can be used for the distribution of natural gas or other fluids. In some cases, regulators can be configured to regulate the pressure of a relevant fluid at a high fluid temperature e.g., with an expected range of about 300-500° C., 350-450° C., 400-450° C., or higher. The repeated exposure to high temperatures can reduce the lifetime of various components of the regulator (e.g., the diaphragm). Available materials for these components, such as stainless steel, can experience crack formation under certain conditions. Other materials that are suitable for high temperature applications are often expensive (e.g., Elgiloy® alloy which is a non-magnetic cobalt-chromium-nickel-molybdenum alloy (Eligiloy is a trademark of Elgiloy Specialty Metals in the United States or other jurisdictions)). There is a need for components that can withstand a wide range of temperatures for extended periods of time, thereby extending the lifetime of the components and the regulator.

Examples of the disclosed technology can include regulator diaphragms or other valve components that are formed from a heat resistant metal matrix composite (MMC) material. In some examples, the composite material can include combinations of aluminum (Al), silicon (Si), cerium (Ce), and strontium (Sr) in particular proportions. In some examples, the composite material can be heat treated and then rolled to a diaphragm thickness.

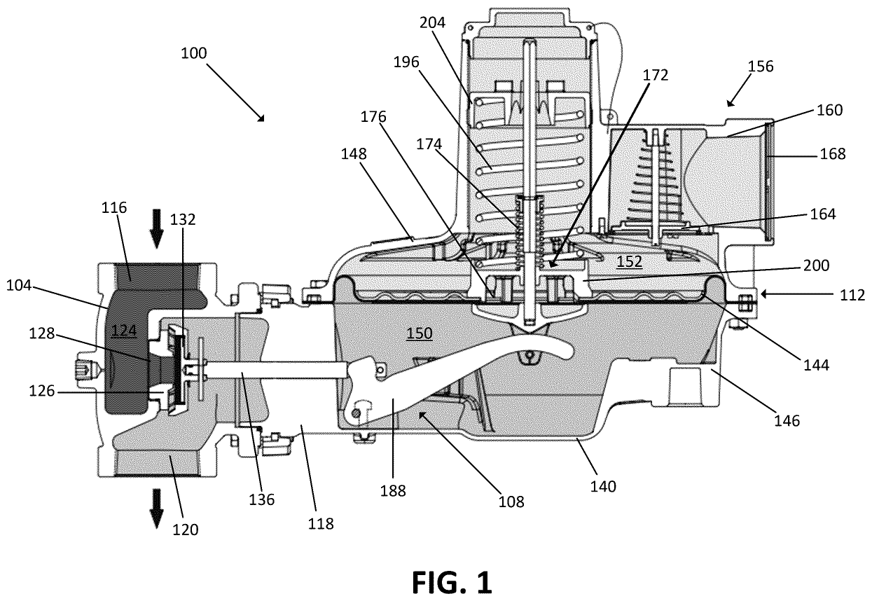

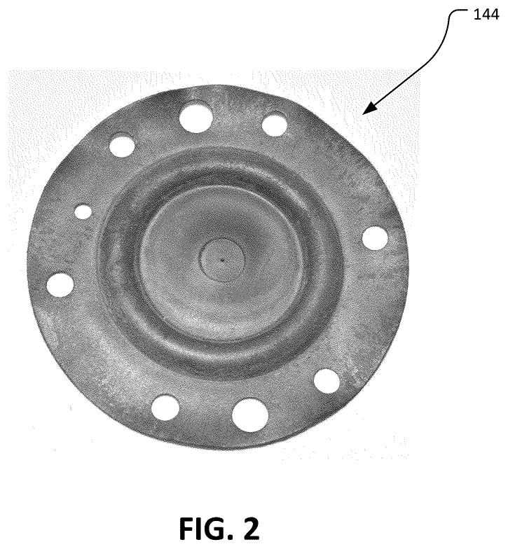

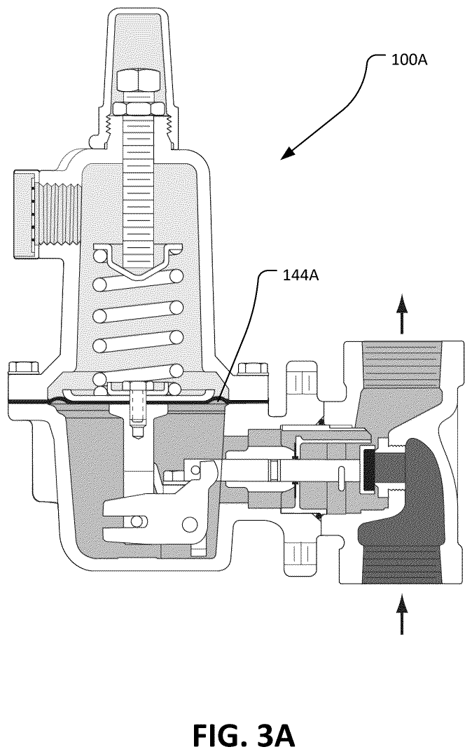

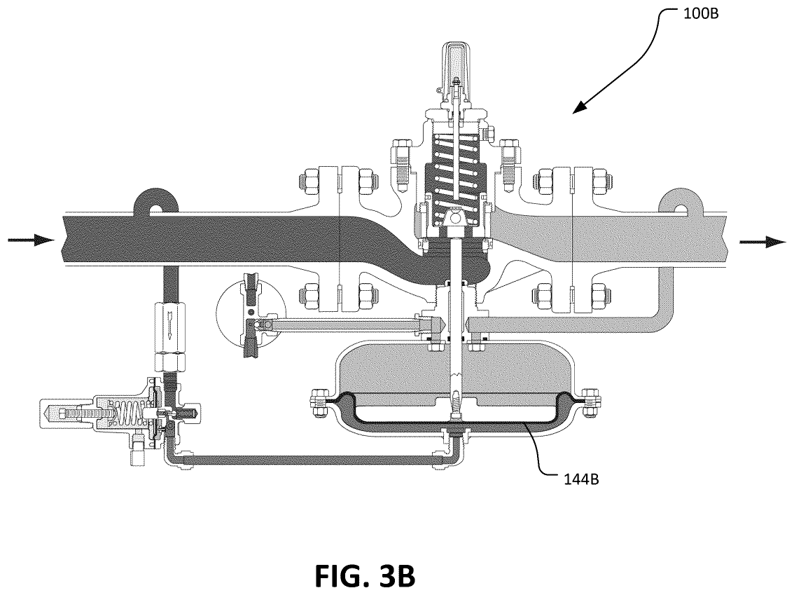

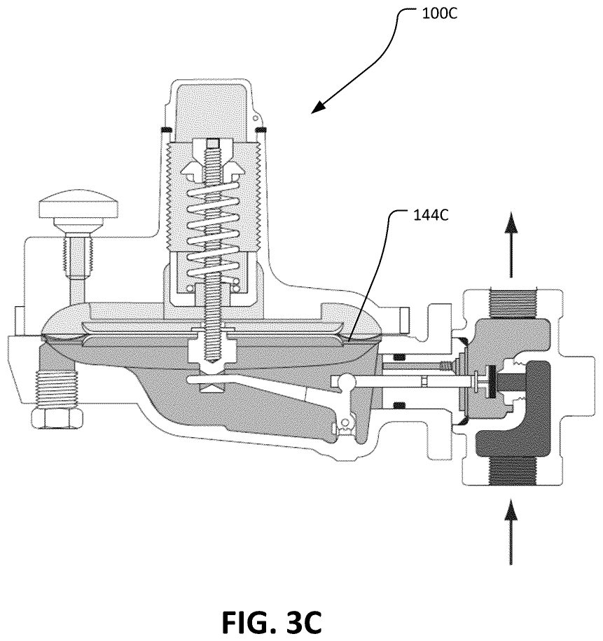

FIG. 1 depicts an example embodiment of a regulator 100 on which aspects of the present disclosure may be practiced. The composite material as disclosed herein can be used for any component of the regulator that is exposed to the fluid that flows through the regulator 100. For example, a diaphragm 144 can be formed from the composite material, with an example configuration as shown in FIG. 2 (e.g., with a diameter of between 1 inch and 8 inches, or larger).

The pressure regulator 100 is generally configured to use in an internal environment (e.g., in a residential building), but the pressure regulator 100 or other pressure regulators on which embodiments of the invention can be implemented can also be installed in an external environment (e.g., outdoors). In this example, the pressure regulator 100 includes a valve body 104, a control assembly 108, an actuator assembly 112, and an internal relief valve 172. In other examples, however, other configurations of pressure regulators are possible, including other configurations on which embodiments of the invention can be beneficially employed. For example, alternative regulators 100A, 100B, 100C with diaphragms 144A, 144B, 144C are illustrated in FIGS. 2A through 2C.

The valve body 104 defines a fluid inlet 116, a fluid outlet 120, and a fluid flow path 124. The fluid flow path 124 extends between the fluid inlet 116 and the fluid outlet 120 when the pressure regulator 100 is in an open configuration (not shown). A flow orifice 128 is disposed in the valve body 104, along the fluid flow path 124, as defined by an orifice assembly 126 disposed between the fluid inlet 116 and the fluid outlet 120. Although the orifice assembly 126 is shown as a single-piece insert with opposing (upstream and downstream) seats for control members, other orifice assemblies can be integrally formed with a valve body, or can be formed as multi-piece assemblies that collectively define a scalable flow orifice with one or more valve seats.

As further described below, the control assembly 108 is configured for displacement in the valve body 104, relative to the orifice assembly 126, to control the flow of fluid through the orifice 128. In the embodiment illustrated, the control assembly 108 includes a control member configured as a valve plug 132, a lever 188, and a valve stem 136 that connects the valve plug 132 to the lever 188, although other configurations are possible. When the pressure regulator 100 is in a closed configuration, as illustrated in FIG. 1, the valve plug 132 is positioned against (i.e., seated on) the orifice assembly 126 thus blocking the flow of process fluid along the flow path 124 (i.e., preventing fluid at the inlet 116 from flowing to the outlet 120).

The actuator assembly 112 is operatively connected to the valve body 104 to control the position of the control assembly 108 relative to the orifice assembly 126. The actuator assembly 112 includes a housing 140, with the diaphragm 144 disposed within the housing 140, and a linkage operatively connecting the diaphragm 144 to the control assembly 108. The actuator housing 140 is formed of a diaphragm case 146 and a spring case 148 that are secured together, such as with one or more bolts connecting respective outer flanges of the cases 146, 148. The diaphragm 144 separates the housing 140 into a first chamber 150 and a second chamber 152. The first chamber 150 is defined at least partly by one side of the diaphragm 144 and the diaphragm case 146. The second chamber 152 is defined at least partly by the other side of the diaphragm 144 and the spring case 148.

An exhaust vent 156 is formed in the spring case 148 and extends into the second chamber 152. The exhaust vent 156 includes an orifice 160 that extends from a vent inlet 164 to a vent outlet 168. The vent inlet 164 is in fluid communication with the second chamber 152 and the vent outlet 168 is in fluid communication with the surrounding ambient atmosphere, such that the exhaust vent 156 fluidly connects the second chamber 152 to the surrounding ambient atmosphere. Correspondingly, in some configurations, the second chamber 152 can be maintained at a pressure that is approximately equal to the pressure of the surrounding ambient atmosphere.

The internal relief valve 172 extends through the diaphragm 144 and is regulated by a relief spring 174. The internal relief valve 172 provides overpressure protection to the downstream system by relieving fluid through the diaphragm 144 to atmosphere in the event of overpressure. Any pressure above the start-to-discharge point of the non-adjustable relief spring 174 moves the diaphragm 144 off the relief seat 176 allowing excess pressure to discharge through the exhaust vent 156.

To control flow through the regulator 100 during normal operation, a first end of the lever 188 is operatively connected to the linkage for the diaphragm 144 and a second end of the lever 188 is operatively connected to the valve stem 136. Accordingly, movement of the diaphragm 144 in response to pressure changes in the first chamber 150 (and at the outlet 120) causes the linkage to move the lever, as further detailed below, which shifts the control assembly 108 to maintain the process fluid within a pre-selected pressure range at the fluid outlet 120.

The actuator assembly 112 also includes a control spring 196, a first spring seat 200, and a second spring seat 204. The first spring seat 200 is disposed on top of the diaphragm 144 within the second chamber 152 of the actuator housing 140, and receives and supports a first end of the control spring 196. The second spring seat 204, which likewise is disposed within the second chamber 152, receives a second end of the control spring 196 opposite the first end. So arranged, the control spring 196 biases the diaphragm 144 in a direction against the fluid pressure (e.g., a downward direction in the orientation shown in FIG. 1) with a selected force, to maintain the pressure of the process fluid within the pre-selected range at the fluid outlet 120. The force exerted by the control spring 196 can be adjusted via the second spring seat 204 or via any other known means, e.g., an adjusting screw. As illustrated in FIG. 1, the actuator assembly 112 may also include components such as, for example, a valve plug and a release spring that are disposed in the internal relief valve 172 and serve to damp the response of the pressure regulator 100.

As noted briefly above, with the pressure regulator 100 configured as shown, the diaphragm-based actuator assembly 112 controls the position of the valve plug 132 of the control assembly 108, relative to the orifice assembly 126, to satisfy desired process control parameters (e.g., a desired set-point pressure). The spring 196 of the actuator assembly 112 naturally biases the diaphragm 144 downward relative to the orientation of FIG. 1, which translates, via the lever 188, into a bias of the control assembly 108 toward an open position (i.e., with the valve plug 132 positioned away from the orifice assembly 126). However, an increase in pressure at the outlet 120, as communicated to the first chamber 150 (e.g., via a throat across the wall 118), can urge the diaphragm 144 upward. Sufficient pressure increase at the outlet 120 can thereby overcome the force applied by the spring 196 to move the diaphragm 144 (e.g., upward in the orientation shown in FIG. 1). This movement of the diaphragm, in turn, can move the lever 188, the valve stem 136, and the valve plug 132 toward the closed position (as shown in FIG. 1). In contrast, when the fluid pressure at the outlet 120 decreases sufficiently, such as in response to an increase in fluid demand downstream of the pressure regulator 100, the spring 196 can overcome the decreased fluid pressure in the first chamber 150 and move the diaphragm 144 (e.g., downward) to move the lever 188, the valve stem 136, and the valve plug 132 back toward the open position.

As shown, the regulator 100 can be configured for use as a backpressure regulator or a pressure reducing regulator, to control the distribution of a fluid (e.g., natural gas) in a distribution system. However, other types of regulators are contemplated for other embodiments. Further, although some discussion herein may be presented in the context of operations particular to a pressure reducing regulator, some embodiments of the invention can be similarly used in the context of back pressure regulators.

During use, various components of the regulator 100 (e.g., the diaphragm 144) can sometimes be subjected to high temperatures. Currently, polymeric materials and steel can be used for the diaphragm 144, which can be subject to significantly shortened lifetime due to high temperatures or other factors. Cycling between high and low temperatures can stress the diaphragm material leading to breakage. To increase the resilience and the lifetime of the diaphragm 144, a new composite material is disclosed herein that is more temperature resistant, among other benefits. In some embodiments, the composite material includes a metal (e.g., aluminum) with grain-refining materials (e.g., cerium, carbon nanofibers). Without wishing to be bound by theory, it is hypothesized that the grain-refining material creates strain in the metal lattice of the composite material to prevent dislocations from passing through the metal lattice. This configuration can allow the composite material to exhibit stability at higher temperatures. In some examples, the grain-refining material can be universally and homogeneously dispersed throughout the composite material to ensure uniform properties throughout the material. It was unexpectedly found that small amounts of the grain-refining materials (e.g., <5% Ce or <1% Sr) improved the strength of the composite material, including as further detailed below.

In one example, the composite material includes aluminum, silicon, and a grain-refining material. In certain examples, the grain-refining material is cerium. In preferred examples, the composite material includes less than 12% Si, or is hypercutectoid Si in Al. These examples exhibit desirable mechanical properties, for example, a 10% deflection in a three-point bend test. In other examples, the composite material can include more than 12% Si, where the composite material exhibits increased brittleness, e.g., only a 3% deflection in a three-point bend test. Similar results may also result from inclusion of relative small amounts of cerium, as also noted above.

In one example, the composite material includes between 70% to 95% Al, between 1% to 25% Si, and between 1% to 15% Ce, by weight, where all percentages are weight percentages. In another example, the composite material includes between 80% to 90% Al, between 2% to 15% Si, and between 4% to 8% Ce. In another example, the composite material includes between 70% to 95% Al, between 1% to 25% Si, and between 8% to 10% Ce, by weight. In one example, the composite material includes 90% Al, 2% Si, and 8% Ce, by weight. In another example, the composite material includes 84% Al, 12% Si and 4% Ce, by weight. In yet another example, the composite material includes 80% Al, 15% Si, and 5% Ce, by weight. In some examples the composite material includes aluminum, silicon, cerium, or strontium. For example, the composite material can include less than 1% strontium.

In some examples, the hardness of the composite material can be between 45-75 HRC.

In some examples, the tensile strength of the composite material can be between 700 MPa and 1200 MPa.

In some examples, the thermal conductivity of the composite material can be at least 12.5 W/m K.

In some examples, the corrosion resistance of the composite material can be comparable to those of ceramic materials, with an improved resistance to H₂S and HCl as compared to traditional steel diaphragms.

As disclosed herein, the composite material demonstrates high strength while maintaining formability, corrosion resistance, and fatigue strength. Additionally, the composite material can perform similarly to current, more costly diaphragm materials (e.g. non-magnetic cobalt-chromium-nickel-molybdenum alloys) with regard to strength and formability. Further, some examples can exhibit a larger operating temperature range, and may be cheaper to produce.

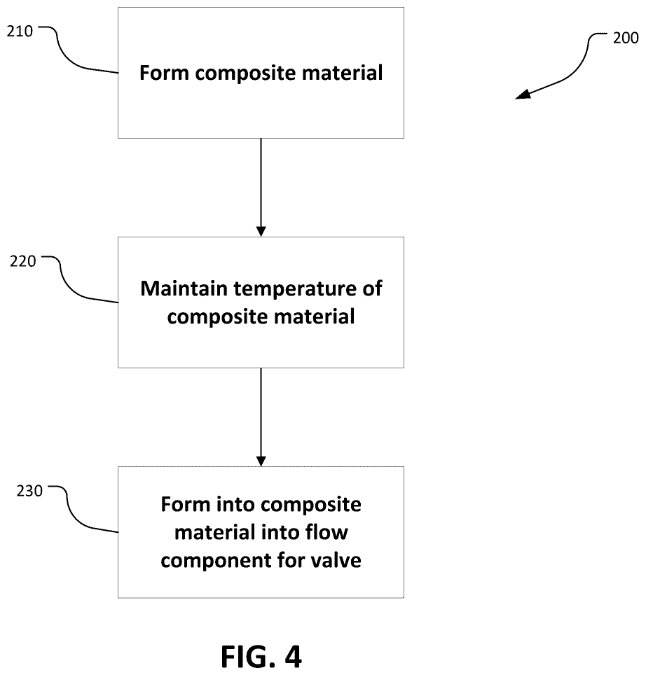

The composite material as disclosed herein can be formed according to various methods. Generally, as illustrated in FIG. 4, a composite material can be formed at operation 210. In various examples, the operation 210 can include combining constituent elemental components in ratios as discussed above, to form the composite material.

In one example, an arc melting process can be used. In another example, a vacuum case system can be used to form the composite material. In some examples, the arc melting process can be conducted in a vacuum to form the composite material. In this method, the composite material is created and manipulated in a vacuum environment to prevent oxidation.

Once prepared, the composite material can be heated to a temperature for hot rolling. The heating can be at a rate of about 100° C./hr, 150° C./hr, 200° C./hr, 250° C./hr, 300° C./hr, or 350° C./hr or for various rates or ranges between those values. Generally, the composite material can be heat treated to remove any residual stress by maintaining the temperature of the material at operation 220 to be above a certain level for a certain time (e.g., as further detailed below). In some examples, the temperature the composite material is heated to and/or maintained at is about 100° C., about 150° C., about 200° C., about 250° C., or about 300° C.

In some examples, the temperature can be maintained at operation 220 concurrently with forming the composite material (e.g., using a hot rolling process). For example, the composite material can be hot rolled while maintaining the temperature above room temperature. Generally, the temperature of the material can be maintained up to, or during, an operation 230 to form the composite material into a flow component (e.g., a diaphragm).

In some examples, order of melting can contribute to formation of homogenous (or more homogenous) microstructure. For example, the Al can be melted first (e.g., in a crucible at a temp around 1000° C.). After the Al has melted, Si (e.g., powdered Si) and grain-refining elements (e.g., Cs, Sr) can be added to the molten Al where the melt is maintained at elevated temperatures in various implementations (e.g., after first breaking an oxide layer). In some cases, a resulting mixture can be further mixed with a stirring stick (e.g., a non-stick alumina stick coated in a Zr wash).

With the elemental components combined as generally presented above to form a melt, the temperature of the melt can then be raised (e.g., to at least 1500° C.) and held for a sufficient time period (e.g., about 1 min to about 1 hour) to ensure that the Si is melted into the Al matrix and is homogeneously distributed. Arc melting or an oven can be used to control the temperature of the melt. In the case of arc melting, the mixing of the powder with the metal pellets is very visible and takes only a short amount of time (e.g., about 1 min) to ensure the distribution is homogeneous. The melt can then be allowed to cool (e.g., to room temperature) at a sufficiently slow rate (e.g, between −100° C./hr and −350° C./hr) to allow precipitate coarsening and thereby promote strength in the material. The rate of cooling can be controlled by the oven. Additionally, and altenratiely, air cooling can be used to cool the melt. The time needed for cooling is controlled by the rate of cooling. Notably, with appropriate order of melting, particularly in combination with slow cooling, various implementations of the process can use conventional oven melting to produce the improved composite diaphragm material and thus keep production costs low.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter. Similarly, unless otherwise indicated, any ranges provided are inclusive of their endpoints.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “a single one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A flow component for a valve, the flow component comprising:
a component body formed from a metal matrix composite material that includes:
between 70 wt. % and 95 wt. % aluminum (Al);
between 1 wt. % and 25 wt. % Silicon (Si); and
between 1 wt. % and 15 wt. % grain-refining material.

2. The flow component of claim 1, wherein the metal matrix composite material includes:
between 80 wt. % and 90 wt. % Al;
between 2 wt. % and 15 wt. % Si; and
between 4 wt. % and 8 wt. % grain-refining material.

3. The flow component of claim 1, wherein the metal matrix composite material includes:
between 8 wt. % and 10 wt. % grain-refining material.

4. The flow component of claim 1, wherein the metal matrix composite material includes:
about 90 wt. % Al;
about 2 wt. % Si; and
about 8 wt. % grain-refining material.

5. The flow component of claim 1, wherein the metal matrix composite material includes:
less than about 15 wt. % Si.

6. The flow component of claim 5, wherein the metal matrix composite material includes:
less than about 12 wt. % Si.

7. The flow component of claim 1 wherein the grain-refining material is selected from the group consisting of cerium, carbon nanofibers, and strontium.

8. The flow component of claim 1, wherein the component body is diaphragm for a regulator.

9. A method of preparing a flow component, the method comprising:
melting aluminum (Al), silicon (Si) and a grain-refining material to form a melt;
raising the temperature of the melt; and
allowing the melt to cool to form a composite material,
wherein the composite material comprises:
between 70 wt. % and 95 wt. % Al;
between 1 wt. % and 25 wt. % Si; and
between 1 wt. % and 15 wt. % grain-refining material.

10. The method according to claim 9, wherein the Al is melted to be molten Al, and the Si and the grain-refining material are combined with the molten Al to form the melt.

11. The method according to claim 9, wherein the temperature of the melt is raised to at least 1500° C. and held for a sufficient time period to ensure the Si has melted into the Al matrix and is homogeneously distributed.

12. The method according to claim 9, wherein the melting is arc melting and is conducted in a vacuum.

13. The method according to claim 9, further comprising:
heating the composite material; and
forming the composite material into a flow component.

14. The method of claim 13, wherein the heating comprises heating the composite material at a rate of between about 100° C./hr and 350° C./hr to a temperature, and maintaining the composite material at the temperature, wherein the temperature is between about 100° C. and about 300° C.

15. The method of claim 9, wherein the flow component is a diaphragm.

16. The method of claim 15, wherein the diaphragm is configured for use in a regulator.

17. A valve comprising:
a valve body that defines an inlet, an outlet, and a fluid flow path from the inlet to the outlet; and
a flow components within the body to control flow of fluid along the fluid flow path,
wherein the flow component is formed from a composite material that includes:
between 70 wt. % and 95 wt. % Al;
between 1 wt. % and 25 wt. % Si; and
between 1 wt. % and 15 wt. % grain-refining material.

18. The valve of claim 17, wherein the valve is a regulator.

19. The valve of claim 18, wherein the flow component is a diaphragm of the regulator.

20. The valve of claim 17, wherein the grain-refining material includes grain-refining materials include one or more of:
less than 1 wt % strontium; or
less than 5 wt % cerium.
